(19) United States
(12) Patent Application Publication
(10) Pub. No.: US 2024/0386237 A1
(43) Pub. Date: Nov. 21, 2024

(54) EFFICIENT OPTIMIZATION OF TENSOR REMATERIALIZATION AND PAGING FOR NEURAL NETWORKS

(71) Applicant: QUALCOMM Incorporated, San Diego, CA (US)

(72) Inventors: Burak BARTAN, San Jose, CA (US); Edward TEAGUE, San Diego, CA (US); Christopher LOTT, San Diego, CA (US)

(21) Appl. No.: 18/495,609

(22) Filed: Oct. 26, 2023

Related U.S. Application Data
(60) Provisional application No. 63/467,136, filed on May 17, 2023.

(51) Int. Cl. G06N 3/02

(52) U.S. Cl. CPC G06N 3/02

(57) ABSTRACT

A processor-implemented method includes receiving a graph representing an artificial neural network (ANN). The graph includes multiple nodes connected by edges and each node represents an operation. Retention intervals are determined for the multiple node outputs based on rematerialization constraints and paging constraints. The retention intervals correspond to a time interval for retaining each node output in at least one local memory. A sequence of tasks for executing the multiple nodes of the graph representing the ANN is determined based on the retention intervals.

### CROSS-REFERENCE TO RELATED APPLICATION

The present application claims the benefit of U.S. Provisional Patent Application No. 63/467,136, filed on May 17, 2023, and titled “EFFICIENT OPTIMIZATION OF TENSOR REMATERIALIZATION AND PAGING FOR NEURAL NETWORKS,” the disclosure of which is expressly incorporated by reference in its entirety.

### FIELD OF THE DISCLOSURE

Aspects of the present disclosure generally relate to artificial neural networks, and more specifically to efficient optimization of tensor rematerialization and paging for neural networks.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Given the many useful applications of neural networks, there is increasing demand for use thereof on edge devices such as smartphones. However, edge devices have limited computational resources and generalized models may utilize more complex networks and more computation. As such, the memory footprint and high latency for neural networks make their use challenging, particularly for efficient deployment and inference on resource-limited devices.

### SUMMARY

The present disclosure is set forth in the independent claims, respectively. Some aspects of the disclosure are described in the dependent claims.

Various aspects of the present disclosure are directed to an apparatus having at least one local memory, at least one global memory, and at least one processor coupled to the at least one local memory and the at least one global memory. The processor(s) is configured to receive a graph representing an artificial neural network (ANN). The graph includes multiple nodes connected by edges and each node represents an operation. The processor(s) is also configured to determine retention intervals for outputs of the multiple nodes based on rematerialization constraints and paging constraints. The retention intervals correspond to a time interval for retaining each node output in the at least one local memory. The processor(s) is further configured to determine a sequence of tasks for executing the multiple nodes based on the retention intervals.

In some aspects of the present disclosure, a processor-implemented method that is performed by at least one processor includes receiving a graph representing an artificial neural network (ANN). The graph includes multiple nodes connected by edges and each node represents an operation. The processor-implemented method also includes determining retention intervals for outputs of the multiple nodes based on rematerialization constraints and paging constraints. The retention intervals correspond to a time interval for retaining each node output in at least one local memory. The processor-implemented method further includes determining a sequence of tasks for executing the multiple nodes based on the retention intervals.

Various aspects of the present disclosure are directed to an apparatus including means for receiving a graph representing an artificial neural network (ANN). The graph includes multiple nodes connected by edges and each node represents an operation. The apparatus also includes means for determining retention intervals for outputs of the multiple nodes based on rematerialization constraints and paging constraints. The retention intervals correspond to a time interval for retaining each node output in at least one local memory. The apparatus further includes means for determining a sequence of tasks for executing the multiple nodes based on the retention intervals.

In some aspects of the present disclosure, a non-transitory computer-readable medium with non-transitory program code recorded thereon is disclosed. The program code is executed by at least one processor and includes program code to receive a graph representing an artificial neural network (ANN). The graph includes multiple nodes connected by edges and each node represents an operation. The program code also includes program code to determine retention intervals for outputs of the multiple nodes based on rematerialization constraints and paging constraints. The retention intervals correspond to a time interval for retaining each node output in at least one local memory. The program code further includes program code to determine a sequence of tasks for executing the multiple nodes based on the retention intervals.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a diagram of an example compute graph, in accordance with various aspects of the present disclosure.

FIG. 6 is a diagram illustrating a simplified example compute graph, in accordance with various aspects of the present disclosure.

FIG. 7 is a graph illustrating execution of a compute graph, in accordance with various aspects of the present disclosure.

FIG. 8 illustrates a processor-implemented method for managing utilization of a memory for executing an artificial neural network (ANN) based on rematerialization and paging, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Large neural network models have been shown to perform very well in a wide variety of domains. Despite the performance and growing popularity of large neural network models, deployment and training of such models in computing devices pose many challenges. For instance, the lower memory capacity of edge devices may be a limiting factor encountered in the deployment of large neural network models.

Many computer architectures for deep neural networks (DNNs) may employ a limited amount of fast, local (on-chip) cache memory in conjunction with a much larger amount of external (off-chip) memory that is significantly slower to access. However, it may not be feasible to only utilize the fast local (on-chip) memory, because the local memory may be limited in size. For example, accelerators for mobile devices today may dedicate several megabytes of local cache per core for storage of intermediate output sensors. However, there are many DNNs in practice where the amount of memory is insufficient to store all of the intermediate outputs. On-device training of resource-limited devices may further exacerbate the deficiency.

Thus, the global (off-chip) memory, which may be larger in size, but may provide slower access compared to the local memory, may be used in conjunction with the local memory. Managing the use of both the local memory and the global memory, while also determining when to execute the tasks in order to minimize the run-time, may result in a difficult combinatorial problem.

Some conventional approaches aim to solve the combinational problem with a naïve sequencing strategy consisting of many smaller computational tasks, which alone do not lead to a local memory feasible solution. For instance, some conventional approaches apply the naïve sequencing strategy to simply sample a random topological order of the computational graph.

Two approaches for reducing local memory footprint are rematerialization and paging. Data dependencies in a computational graph may dictate which tensors should be resident in local memory for a valid execution. Rematerialization refers to discarding the output of a node and recomputing the node operation for a successor node later in the sequence. Because memory space is not allocated for the discarded output, the memory footprint may be reduced.

On the other hand, paging may refer to a memory management technique in which intermediate node outputs stored in local memory may be sent to a global (e.g., off-chip) memory, which may be referred to as paging out (may also be referred to as “spill”). Additionally, the output of an operation may be retrieved from the global memory and stored in the local memory, which may be referred to as paging in (may also be referred to as “fill”). By paging out the intermediate node outputs to the global memory, the memory footprint of the local memory may be reduced.

Although paging may offer more flexibility in reducing the peak local memory than rematerialization (because it does not involve the outputs of predecessor nodes), paging may provide the flexibility at the expense of increased communication to/from the off-chip memory. Although the global memory is larger in size (capacity), accessing the off-chip memory may be much slower in comparison to local memory operations. Thus, relying on paging alone to lower the local memory footprint may lead to increased use of the off-chip memory bus, resulting in a bottleneck.

Accordingly, aspects of the present disclosure are directed to determining a sequence of tasks for artificial neural networks using rematerialization and paging. Particular aspects of the subject matter described in this disclosure can be implemented to realize one or more of the following potential advantages. In some examples, the described techniques, such as joint optimization of tensor rematerialization and paging may reduce peak memory utilization and memory footprint as well as inference latency.

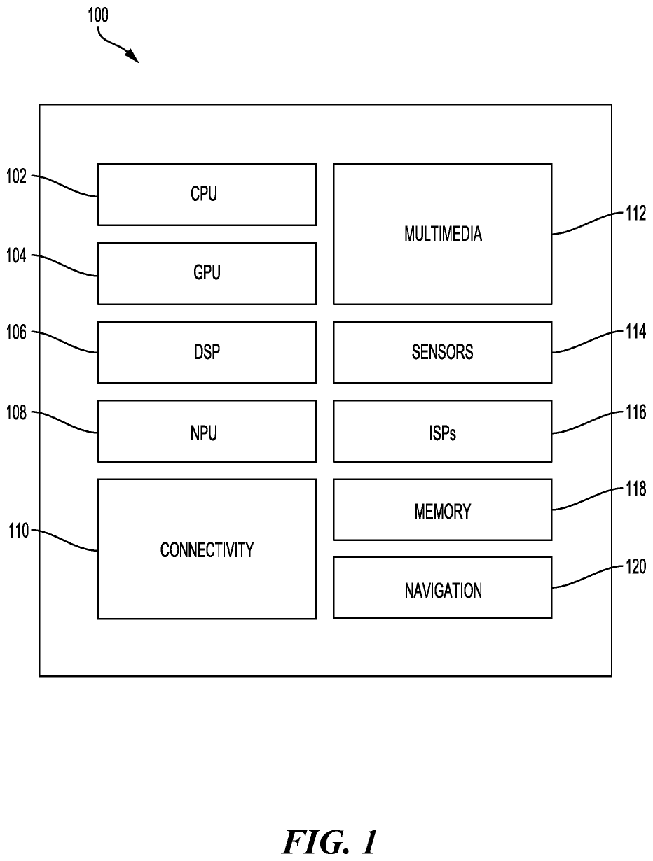

FIG. 1 illustrates an example implementation of a system-on-a-chip (SOC) 100, which may include a central processing unit (CPU) 102 or a multi-core CPU configured for determining a sequence for computing operations in an artificial neural network based on tensor rematerialization and paging. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code to receive a graph representing an artificial neural network (ANN). The graph includes multiple nodes connected by edges and each node represents an operation. The general-purpose processor 102 may also include code to determine retention intervals for outputs of the multiple nodes based on rematerialization constraints and paging constraints. The retention intervals correspond to a time interval for retaining each node output in at least one local memory. The general-purpose processor 102 may further include code to determine a sequence of tasks for executing the multiple nodes based on the retention intervals.

Deep learning architectures may perform an object recognition task by learning to represent inputs at successively higher levels of abstraction in each layer. thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

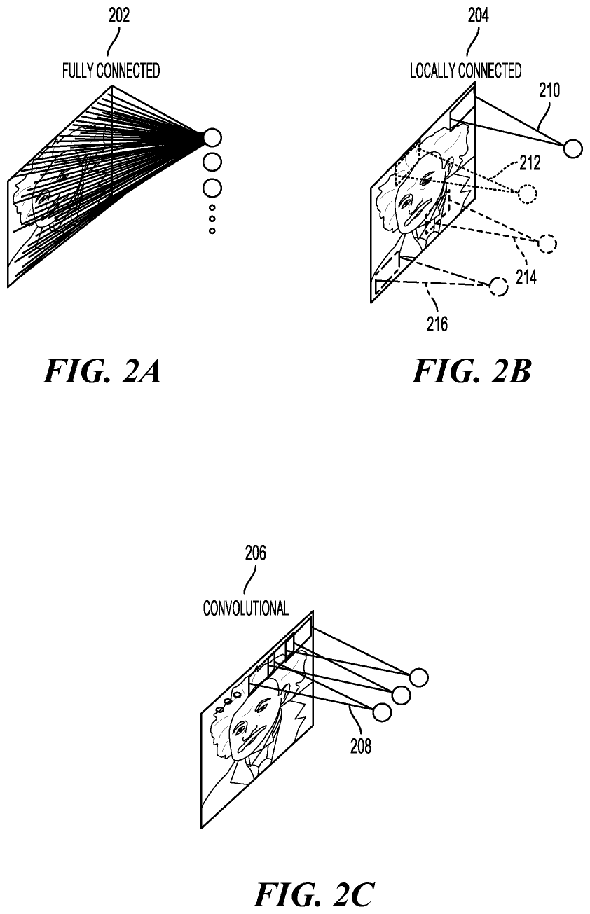

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

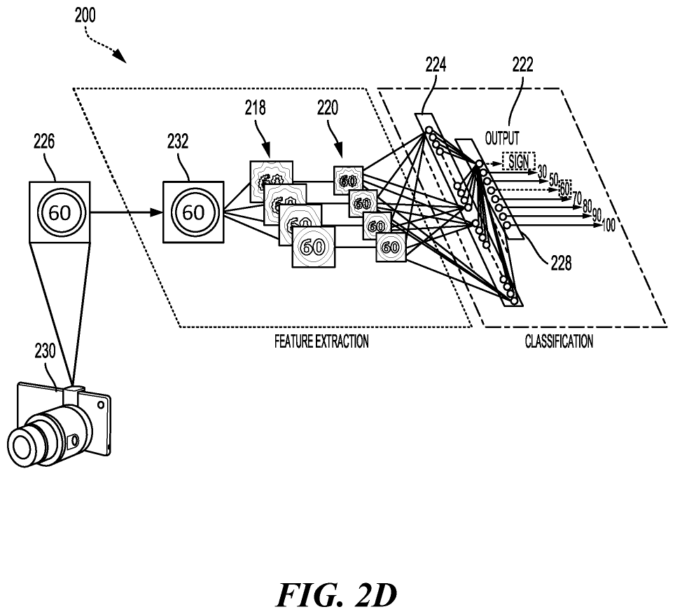

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a DCN may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

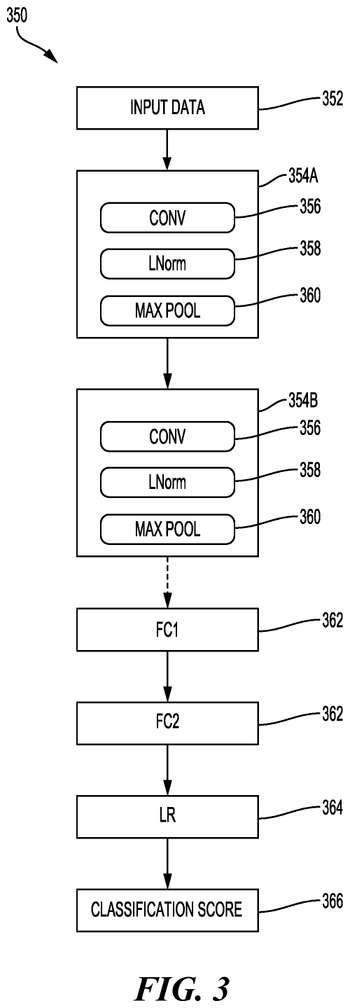

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) to support adaptive rounding as disclosed for determining a sequence for computing operations in an artificial neural network based on tensor rematerialization and paging for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

Aspects of the present disclosure are directed to determining a sequence of tasks for artificial neural networks using rematerialization and paging.

In accordance with aspects of the present disclosure, output retention intervals may model a duration or time interval for retaining an output of a node of a compute graph in a local memory. The compute graph may represent an artificial neural network, for example. The nodes of the compute graph may represent operations. A set of edges may connect the nodes of the compute graph. The edges may represent a data dependency among the nodes. The compute graph may comprise a directed acyclic graph (DAG), for example.

For each node, C retention intervals may be defined, where each interval represents a time period for retaining the node output in a local memory such as a tightly-coupled memory (TCM) or on-chip memory (e.g., memory 118 of SOC 100 shown in FIG. 1). The starting times sᵥⁱ of the intervals and the ending times eᵥⁱ of the intervals may be determined based on rematerialization constraints and paging constraints.

The rematerialization constraints may be determined based on data dependencies between the nodes, for instance, defining a number of times that a node may be recomputed. The rematerialization constraints may define whether a node output may be discarded at the end of an interval.

The paging constraints may define a number of times that a node output may be paged out from a local memory to a global memory, for example. The paging constraints may define whether a node output may be paged in. For instance, the paging constraints may indicate that a node output may not be paged in to start the first interval.

In some aspects, the retention intervals may be determined using a joint optimization of communication between the local memory and a global memory based on the rematerialization constraints and the paging constraints. As such, the determination of which of the nodes to recompute and which outputs to page out may be solved numerically. Furthermore, a sequence of tasks, including the original compute tasks, recompute tasks, and paging tasks may be determined for executing the nodes of an artificial neural network (ANN), such that communication between the local memory and the global memory may be reduced while also satisfying data dependencies and the memory constraint (e.g., memory budget such as a TCM capacity e.g., eight megabytes (8 MB)).

In various aspects, the objective of minimizing the communication to/from the off-chip memory may be considered.

Neural network training or inference tasks may be represented using computational graphs. For instance, neural network tasks may be represented using a directed acyclic graph (DAG). Given a DAG G with n=|V| nodes and m=|E| edges, G=(V, E), the nodes v∈V may correspond to computational tasks and the edges (u, v)∈E may specify data dependencies for the tasks. That is, to compute node v, each of the outputs of its predecessors u have to be resident (stored) in local memory. The output size my and duration wy (amount of time the output has to be stored in memory), may be given for each node v. A sequence seq(G), which may be considered an ordered list of tasks, may be determined. However, the seq(G) is not limited to the original nodes of G, but rather, may also include repeated nodes (e.g., rematerialization) and page in and page out operations.

The sequence of tasks seq(G) may be determined to reduce, and in some aspects minimize, communication between the local and global memory and satisfies the data dependency requirements. Additionally, in some aspects, the sequence of tasks seq(G) may also be determined such that a peak local memory is below a threshold M, and satisfies a compute time budget W.

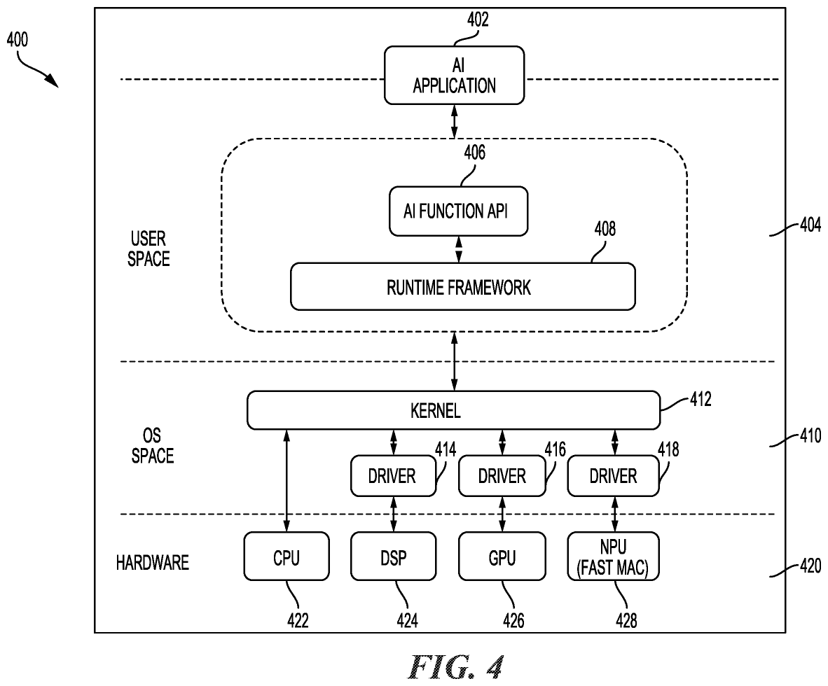

FIG. 5 is a diagram of an example compute graph 500, in accordance with various aspects of the present disclosure. Referring to FIG. 5, the compute graph 500 may comprise a DAG. The compute graph 500 may include multiple nodes 502a-z (collectively 502) coupled by edges 504a-n (collectively 504). For case of illustration, two nodes 502 and two edges 504 are labeled. The compute graph 500 may represent an artificial neural network (ANN). Each node 502 may represent a computational task and the edges 504 may represent data dependencies among the nodes (tasks). In some aspects, the nodes 502 of the compute graph 500 may represent neural network layers or partitions of layers representing smaller tasks generated during compilation, for instance. As such, the compute graph 500 may also include a higher node count as well as a more complicated topology.

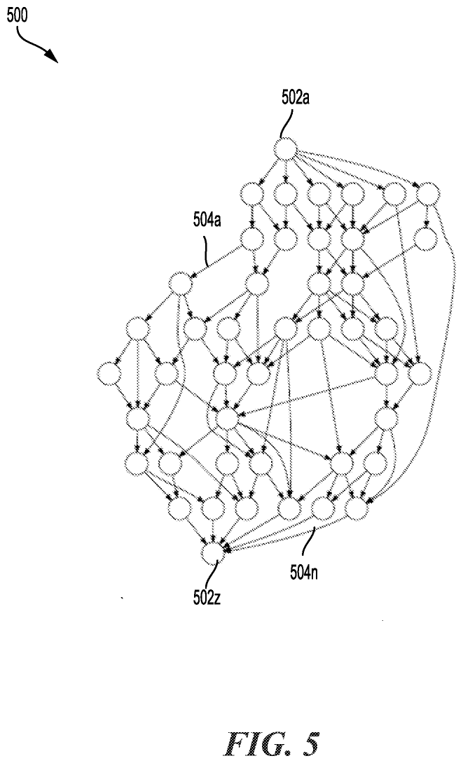

FIG. 6 is a diagram illustrating a simplified example compute graph 600, in accordance with various aspects of the present disclosure. The compute graph 600 may include multiple nodes 602a-e (collectively 602) coupled by edges 604a-e(collectively 604). The compute graph 600 may represent an artificial neural network (ANN), for example. Each node 602 may represent a computational task and the edges 604 may represent data dependencies among the nodes (tasks). Although five nodes 602a-e and five edges 604a-e are shown in FIG. 6, the present disclosure is not so limiting and any number of nodes and edges may be included in the compute graph 600.

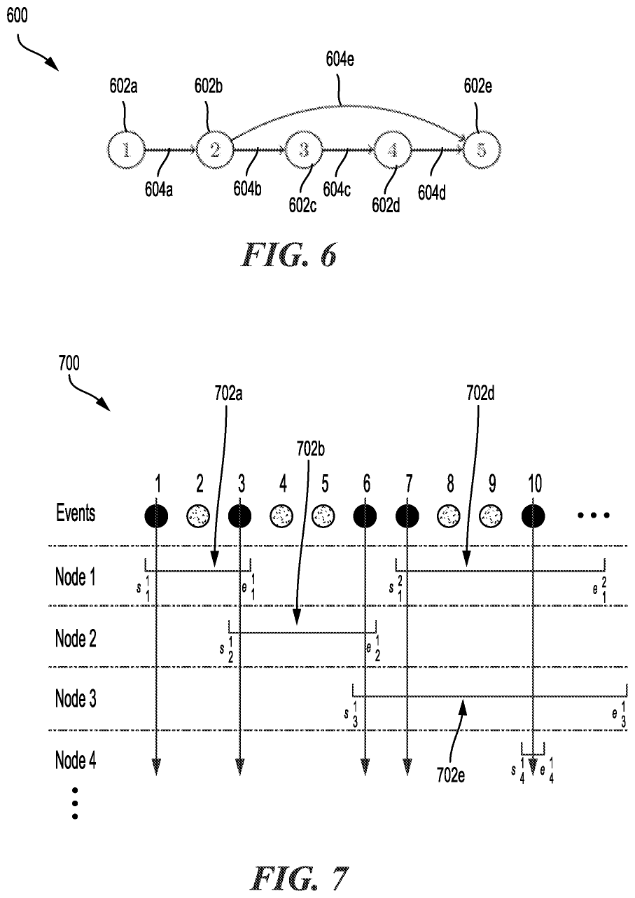

FIG. 7 is a graph 700 illustrating execution of the compute graph 600, in accordance with various aspects of the present disclosure. Referring to FIG. 7, a set of potential node execution events are shown for executing nodes 1-4 of the example compute graph 600. In accordance with some aspects of the present disclosure, retention intervals (e.g., 702a-e) for execution of each of the nodes may be determined. Five retention intervals are shown in the example of FIG. 7, however, this is merely for ease of illustration and not limiting. Rather, it should be understood that any number of retention interval may be determined in accordance with the nodes 602 of the compute graph 600.

For each retention interval (e.g., 702a-e), a first time slot (shown using a filled event circle) may indicate the computation of node v, while the rest of the retention intervals (e.g., 702a-e) may indicate the retention of the output of node v in memory (e.g., memory 118 shown in in FIG. 1). The other event circles shown with a fill pattern (e.g., event 2) may indicate that no retention interval starts at that particular time (e.g., no computation occurs). However, the determination of the node execution events may be a by-product of the optimization problem and may not be known ahead of time.

As shown in the example of FIG. 7, node 1 may be computed during event 1. Because the operation of node 2 depends on the output of node 1, the node 1 output may be retained in memory until event 3. At event 3, node 2 may be executed and the node 2 output may be retained in the memory until event 6.

After event 3, the node 1 output may be discarded or may be paged out. However, because the operation of node 4 also depends on the node 1 output, the node 1 output may be recomputed. A second interval for node 1 may start at event 7, indicating that node 1 may be recomputed or paged in during event 7.

Referring back to FIG. 6, the output sizes for each of the nodes 602 may be given as follows: m₁=m₂=1, m₃=2, and m₄=m₅=1. Based on the precedence constraints indicated by the edges 604, there may be only one valid topological order for the compute graph 600 of 1, 2, 3, 4, 5. When nodes 602 are executed in the valid topological order, the allocated memory at the execution event of each node may be as follows: ({1}, {1, 2}, {2, 3}, {2, 3, 4}, {2, 4, 5}). As such, the sum of output sizes at each execution event may be as follows (1, 2, 3, 4, 3).

However, if the available local memory budget (e.g., capacity) is three, then executing the graph may not be performed without resorting to rematerialization or paging because the peak memory is four. On the other hand, rematerialization may enable the execution of the compute graph 600 for a memory budget of three. For instance, the output of node 2 (602b) may be discarded after execution of node 3 (602c). Then, the output of node 2 (602b) may be rematerialized before node 5 (602e) is executed. As such, the outputs retained in the local memory at each execution event may be as follows: ({1}, {1, 2}, {2, 3}, {3, 4}, {1, 4}, {1, 2, 4}, {2,4, 5}). Thus, the memory utilization at each execution event may be (1, 2, 3, 3, 2, 3, 3) with the peak utilization of three. However, the total duration of maintaining an output in memory (e.g., local memory) may be increased as a result of recomputing nodes 1 and 2 (e.g., a trade-off of peak memory utilization with compute (duration)).

However, consider the case when the output sizes for each node are respectively as follows: output sizes: m₁=2, m₂=1, m₃=2, m₄=m₅=1. In such a case, given a local memory budget of three, it may not be possible to reduce the peak memory within the memory budget using rematerialization only. However, paging may also be employed to execute the compute graph 600. For instance, rather than rematerialize node 2 (602b), node 2 (602b) may be paged out. Because the output of node 1 (602a) has to be resident in local memory for the rematerialization of node 2 (602b), the peak local memory utilization may be reduced from four (because node 1 (602a) has output size 2) to three, as paging does not involve the output of node 1 (602a). Accordingly, a sequence of tasks having a peak memory of three may be determined: (1, 2, page out 2, 3, 4, page in 2, 5). Thus, the outputs retained in memory at each node execution event for the determined sequence may be: ({1}, {1, 2}, {1, 2}, {2, 3}, {3, 4}, {2, 4}, {2, 4, 5}).

In various aspects of the present disclosure, an event-based optimization is provided. Depending on the context and specific application, it may be necessary to formulate different objectives. The disclosed techniques may provide flexibility for considering different objectives such as latency or energy usage.

In some aspects, the event-based optimization techniques may focus on the objective of minimizing the communication load between the local and global memory (may be referred to as “communication load” or “dynamic random access memory (DRAM) traffic”). Because a memory bus may often be a shared resource among multiple applications running simultaneously or concurrently within a computing system, optimizing the communication load may be useful.

A retention interval may be defined for each time a node (e.g., 602) is computed or paged in. The retention interval may be defined such that the beginning of the retention interval indicates either a compute or page in event, while the rest of the retention interval may indicate the retention of an output (e.g., an output tensor) in a local memory. The endpoints of the intervals may be modeled as variables. The i′th time that node v is in the local memory (e.g., through compute (rematerialization) or paging) may have the associated interval start variable and end interval variables:

$${s}_{v}^{i} , {e}_{v}^{i} ∈ D , ∀ i ∈ \{ 1 , … , {C}_{v} \} , \qquad ( 1 )$$

where sᵥⁱ represents the start interval variable, eᵥⁱ represents the end interval variable, and D denotes the domain of the variables. The number of retention intervals for a node v may be limited by a parameter Cᵥ. The parameter Cᵥ may directly impact the complexity of the communication load optimization problem as the number of decision variables may scale linearly with the parameter Cᵥ. In practice, selecting a low value for the parameter Cᵥ, may not lead to sub-optimal solutions. Furthermore, the parameter Cᵥ, may serve as an upper limit for the number of intervals for node v, which may be accounted for by defining Boolean variables aᵥⁱ, to allow for a portion of the Cᵥ intervals to be inactive. For example, aᵥⁱ=1 may indicate that the i′th interval of node v is active, and aᵥⁱ=0 may indicate that the associated interval is inactive.

In addition, a parameter indicating whether a node is computed or paged in at the beginning of an interval and whether a tensor is discarded or paged out at the end of an interval may be defined. The Boolean decision variables for such decisions may be given by:

$${p}_{v}^{i} , {q}_{v}^{i} ∈ \{ 0 , 1 \} , \qquad ( 2 )$$

where pᵥⁱ indicates the beginning of an interval and qᵥⁱ indicates the end of an interval. For example, pᵥⁱ=1 may indicate that the i′th interval of the node v is paged in while pᵥⁱ=0 may indicate that the i′th interval of the node v is rematerialized (e.g., computed) at the beginning of an interval. For the end of an interval, qᵥⁱ=1 may indicate that the node v output is paged out and qᵥⁱ=0 may indicate that the node v output is discarded. Using the defined Boolean variables, the full problem specification may be expressed as follows:

$${p}_{v}^{i} , {q}_{v}^{i} ∈ \{ 0 , 1 \} , \qquad ( 2 )$$

$${minimize}_{{s}_{v}^{i} , {e}_{v}^{i} , {a}_{v}^{i} , {p}_{v}^{i} , {q}_{v}^{i} , v ∈ V , i ∈ [ {C}_{v} ]} {\sum }_{v , i} {p}_{v}^{i} {m}_{v} + {q}_{v}^{i} {m}_{v} \qquad ( 3 )$$

$$Subject to {s}_{v}^{i} \leq {e}_{v}^{i} , ∀ v , i \qquad ( 4 )$$

$${e}_{v}^{i} \leq {s}_{v}^{i + 1} , ∀ v , ∀ i < {C}_{v} \qquad ( 5 )$$

$${\sum }_{v , i : {s}_{v}^{i} \leq t \leq {e}_{v}^{i}} {m}_{v} {a}_{v}^{i} \leq M , ∀ t ∈ D \qquad ( 6 )$$

$$∀ ( u , v ) ∈ E , ∀ i ∈ \{ i : {a}_{v}^{i} = 1 \} , ∃ j such that {a}_{u}^{u} = 1 , and \\ ( 1 - {p}_{v}^{i} ) ( {s}_{j}^{u} + 1 ) \leq ( 1 - {p}_{v}^{i} ) {s}_{v}^{i} \leq ( 1 - {p}_{v}^{i} ) {e}_{u}^{j} \qquad ( 7 )$$

$${s}_{v}^{i} \neq {s}_{u}^{j} , ∀ v , u ∈ \{ v , u : v \neq u \} , ∀ i , j \qquad ( 8 )$$

$${p}_{v}^{i} \leq {\sum }_{j < i} {q}_{v}^{j} , ∀ v , i > 1 , {p}_{v}^{1} = 0 , ∀ v \qquad ( 9 )$$

$${\sum }_{v , i} {w}_{v} {a}_{v}^{i} ( 1 - {p}_{v}^{i} ) \leq W \qquad ( 10 )$$

$${p}_{v}^{i} \leq {a}_{v}^{i} , {q}_{v}^{i} \leq {a}_{v}^{i} , ∀ v , i \qquad ( 11 )$$

$${a}_{v}^{1} = 1 , ∀ v \qquad ( 12 )$$

$${s}_{v}^{i} , {e}_{v}^{i} ∈ D , {p}_{v}^{i} , {q}_{v}^{i} , {a}_{v}^{i} ∈ \{ 0 , 1 \} , ∀ v , i . \qquad ( 13 )$$

$${\sum }_{i} {q}_{v}^{i} \leq 1 , ∀ v . \qquad ( 14 )$$

The objective in Equation 3 may correspond to the communication load between the local memory and the global memory. The communication load may be equivalent to the sum of output sizes for all of the paged nodes v. Equations 4 and 5 may provide constraints to enforce the validity and ordering for the retention intervals. Equations 6 and 7 may respectively provide a memory constraint and a data dependency constraint. The constraints in Equations 4-7 may be nonlinear constraints in the problem variables.

Equation 8 may specify that the start times of the intervals may be enforced to be different such that one compute task is performed at a time. The constraint in Equation 9 may provide that a page-in may occur only if that output tensor has previously been paged out. The second inequality in Equation 9 may indicate that the first interval for the node v may not start with a page-in because it may not be possible that the node v output has been paged out previously.

Equation 10 may specify a compute time budget constraint W, where W represents a user-defined parameter that may limit the total compute time incurred due to recompute of operations. The constraints in Equation 11 may limit the paging variables pᵥⁱ such that the paging variables pᵥⁱ may only be true if the corresponding interval is active. Equation 12 may provide that every node is computed at least once. and also breaks the interval symmetry by designating the first interval of the Cᵥ intervals as active. Equation 13, in turn, defines the domains of each of the variables. The exact definition for the domain D may thus depend on whether an arbitrary topological ordering of the nodes is permitted, in which case, the topology may be defined as D={1,2, . . . , ΣᵥCᵥ}.

It follows from the definition of paging that the same node may not be paged out twice (shown in Equation 14). If the objective is to minimize the communication load due to paging, then a constraint to ensure nodes are paged out at most once may not be used. For other types of objectives, Equation 14 may be included explicitly as a separate constraint.

In some aspects, the variables pᵥⁱ, and qᵥⁱ may be set to reduce the joint optimization problem to individual optimizations. For example, by setting the paging start interval pᵥⁱ=1 for all i>1 may reduce the problem of paging optimization because pᵥⁱ=1 may enforce that node v is paged in for its i′th interval. Similarly, by setting the paging start interval pᵥⁱ=0 for all i may turn off paging for node v, thus allowing only rematerialization. In this case, the objective may also be changed because for rematerialization only, there may be no associated DRAM traffic (communication load). In some aspects, the total execution duration minimization may be considered. Furthermore, if both rematerialization and paging are inactive, then the resulting optimization problem may be reduced to the node sequencing problem in DAGs. For instance, Cᵥ may be set to one for all nodes v∈V. Accordingly, the number of retention intervals may be reduced to one for every node (e.g., a sequencing problem). In some aspects, an objective in such a case could be the peak local memory.

The memory constraint and data dependency constraints expressed in Equations 6 and 7, respectively, may be modeled using functions from constraint programming. For example, cumulative programming may be used for the memory constraints where the tensor output sizes may be modeled as resources whose maximum capacity is maintained below the local memory budget. Furthermore, the data dependency constraints may be modeled using reservoir constraints where predecessor nodes may be considered as resources. However, unlike conventional approaches, which may only consider rematerialization, the data dependency constraints may be enforced for compute or recompute events because paging in does not depend on the predecessor outputs being resident in local memory.

The optimization problem as stated in Equations 3-13 may not be dependent on a fixed topological ordering of nodes. A solution to the optimization problem may be determined, for example, using a numerical constraint programming solver. The solution may then be mapped to a sequence of tasks. For instance, the start and end times of each interval may indicate the order in which tasks (e.g., nodes) are to be executed. The variables pᵥⁱ, qᵥⁱ may then determine the specific operation through which the corresponding task is executed (e.g., paging or rematerialization). For example, when pᵥⁱ=1, the operation of node v may be performed by paging in and when pᵥⁱ=0, the operation of node v may be performed by computing (rematerializing) the task specified by node v. Similarly, the value of qᵥⁱ may determine whether the output tensor is discarded or paged out to the global memory.

Accordingly, the number of variables of the optimization problem in Equations 3-13 may be on the order of O(ΣᵥCᵥ). For fixed Cᵥ=C, ∀v∈V, the number of variables of the optimization problem becomes O(Cn) variables. The start and end times of the retention intervals may be integers from a domain of size O(n), while the rest of the variables are Boolean. If represented in terms of only Boolean decision variables, then the corresponding problem would have O (Cn logn) Boolean variables. In contrast, the number of Boolean decision variables for some conventional approaches is O(n²). Therefore, aspects of the present disclosure may also beneficially reduce the complexity of the combinational optimization problem relative to conventional techniques.

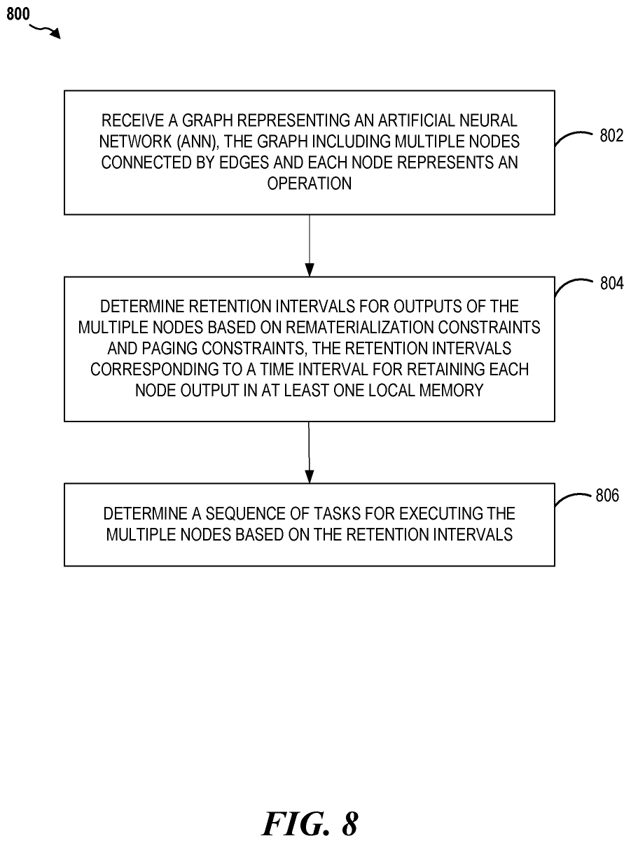

FIG. 8 illustrates a processor-implemented method 800 for managing utilization of at least one memory for executing an artificial neural network (ANN) based on rematerialization and paging, in accordance with various aspects of the present disclosure. The processor-implemented method 800 may be performed by one or more processors such as the CPU (e.g., 102, 422), GPU (e.g., 104, 426), and/or other processing units (e.g., DSP 424 or NPU 428), for example. In some aspects the processor-implemented method 800 may be implemented by a compiler, for instance.

As shown in FIG. 8, at block 802, a processor receives a graph representing the ANN. The graph includes multiple nodes connected by edges and each node represents an operation. For instance, as shown in FIG. 5, the compute graph 500 may comprise a DAG. The compute graph 500 may include multiple nodes 502a-z(collectively 502) coupled by edges 504a-n (collectively 504). For ease of illustration, two nodes 502 and two edges 504 are labeled. The compute graph 500 may represent an artificial neural network (ANN). Each node 502 may represent a computational task and the edges 504 may represent data dependencies among the nodes (tasks). In some aspects, the nodes 502 of the compute graph 500 may represent neural network layers or partitions of layers representing smaller tasks generated during compilation, for instance.

At block 804, the processor determines retention intervals for outputs of the multiple nodes based on rematerialization constraints and paging constraints. The retention intervals correspond to a time interval for retaining each node output in at least one local memory. As described for instance with respect to FIG. 6, a retention interval may be defined for each time a node (e.g., 602) is computed or paged in. The retention interval may be defined such that the beginning of the retention interval indicates either a compute or page in event, while the rest of the retention interval may indicate the retention of an output (e.g., an output tensor) in at least one local memory. The endpoints of the intervals may be modeled as variables. The i′th time that node v is in the at least one local memory (e.g., through compute (rematerialization) or paging) may have the associated interval start variable and end interval variables according to Equations 2-13, for example.

At block 806, the processor determines a sequence of tasks for executing the multiple nodes based on the retention intervals. For instance, as described, a solution to the optimization problem may be determined, for example, using a numerical constraint programming solver. The solution may then be mapped to a sequence of tasks. For instance, the start and end times of each interval may indicate the order in which tasks (e.g., nodes) are to be executed. The variables pᵥⁱ, qᵥⁱ may then determine the specific operation through which the corresponding task is executed (e.g., paging or rematerialization).

Implementation examples are provided in the following numbered clauses:
1. An apparatus, comprising:
   at least one local memory;
   at least one global memory; and
      at least one processor coupled to the at least one local memory and the at least one global memory, the at least one processor configured to:
      receive a graph representing an artificial neural network (ANN), the graph including multiple nodes connected by edges and each node represents an operation;
      determine retention intervals for outputs of the multiple nodes based on rematerialization constraints and paging constraints, the retention intervals corresponding to a time interval for retaining each node output in the at least one local memory; and
      determine a sequence of tasks for executing the multiple nodes based on the retention intervals.
2. The apparatus of clause 1, in which the retention intervals are determined using a joint optimization of communication between the at least one local memory and the at least one global memory based on the rematerialization constraints and the paging constraints to reduce the communication between the at least one local memory and the at least one global memory.
3. The apparatus of clause 1 or 2, in which the communication between the at least one local memory and the at least one global memory is conducted using a double data rate (DDR) bus.
4. The apparatus of any of clauses 1-3, in which the paging constraints define a quantity of times node outputs are paged out from the at least one local memory to the at least one global memory.
5. The apparatus of any of clauses 1-4, in which the paging constraints defines whether node outputs are paged into the at least one local memory from the at least one global memory or paged out from the at least one local memory to the at least one global memory.
6. The apparatus of any of clauses 1-5, in which the rematerialization constraints define a quantity of times that a node is permitted to be recomputed.
7. The apparatus of any of clauses 1-6, in which the rematerialization constraints include data dependencies determined based on the edges connecting the multiple nodes.
8. The apparatus of any of clauses 1-7, in which the at least one local memory comprises at least one tightly-coupled memory.
9. A processor-implemented method comprising:
   receiving a graph representing an artificial neural network (ANN), the graph including multiple nodes connected by edges and each node represents an operation;
   determining retention intervals for outputs of the multiple nodes based on rematerialization constraints and paging constraints, the retention intervals corresponding to a time interval for retaining each node output in at least one local memory; and
   determining a sequence of tasks for executing the multiple nodes based on the retention intervals.
10. The processor-implemented method of clause 9, in which the at least one processor is further configured to determine the retention intervals using a joint optimization of communication between the at least one local memory and at least one global memory based on the rematerialization constraints and the paging constraints to reduce the communication between the at least one local memory and the at least one global memory.
11. The processor-implemented method of clause 9 or 10, in which the communication between the at least one local memory and the at least one global memory is conducted using a double data rate (DDR) bus.
12. The processor-implemented method of any of clauses 9-11, in which the paging constraints define a quantity of times node outputs are paged out from the at least one local memory to at least one global memory.
13. The processor-implemented method of any of clauses 9-13, in which the paging constraints define whether node outputs are paged into the at least one local memory from at least one global memory or paged out from the at least one local memory to the at least one global memory.
14. The processor-implemented method of any of clauses 9-14, in which the rematerialization constraints define a quantity of times that a node is permitted to be recomputed.
15. The processor-implemented method of any of clauses 9-15, in which the rematerialization constraints include data dependencies determined based on the edges connecting the multiple nodes.
16. The processor-implemented method of any of clauses 9-16, in which the at least one local memory comprises at least one tightly-coupled memory.
17. A non-transitory computer-readable medium having program code recorded thereon, the program code executed by a processor and comprising:
   program code to receive a graph representing an artificial neural network (ANN), the graph including multiple nodes connected by edges and each node represents an operation;
   program code to determine retention intervals for outputs of the multiple nodes based on rematerialization constraints and paging constraints, the retention intervals corresponding to a time interval for retaining each node output in at least one local memory; and
   program code to determine a sequence of tasks for executing the multiple nodes based on the retention intervals.
18. The non-transitory computer-readable medium of clause 17, in which the program code comprises program code to determine the retention intervals using a joint optimization of communication between the at least one local memory and at least one global memory based on the rematerialization constraints and the paging constraints to reduce the communication between the at least one local memory and the at least one global memory.
19. The non-transitory computer-readable medium of clause 17 or 18, in which the communication between the at least one local memory and the at least one global memory is conducted using a double data rate (DDR) bus.
20. The non-transitory computer-readable medium of any of clauses 17-19, in which the paging constraints define a quantity of times node outputs are paged out from the at least one local memory to at least one global memory.
21. The non-transitory computer-readable medium of any of clauses 17-20, in which the paging constraints defines whether node outputs are paged into the at least one local memory from at least one global memory or paged out from the at least one local memory to the at least one global memory.
22. The non-transitory computer-readable medium of any of clauses 17-22, in which the rematerialization constraints define a quantity of times that a node is permitted to be recomputed.
23. The non-transitory computer-readable medium of any of clauses 17-23, in which the rematerialization constraints include data dependencies determined based on the edges connecting the multiple nodes.
24. An apparatus, comprising:
   means for receiving a graph representing an artificial neural network (ANN), the graph including multiple nodes connected by edges and each node represents an operation;
   means for determining retention intervals for outputs of the multiple nodes based on rematerialization constraints and paging constraints, the retention intervals corresponding to a time interval for retaining each node output in at least one local memory; and
   means for determining a sequence of tasks for executing the multiple nodes based on the retention intervals.
25. The apparatus of clause 24, further comprising means for determining the retention intervals using a joint optimization of communication between the at least one local memory and at least one global memory based on the rematerialization constraints and the paging constraints to reduce the communication between the at least one local memory and the at least one global memory.
26. The apparatus of clause 24 or 25, in which the communication between the at least one local memory and the at least one global memory is conducted using a double data rate (DDR) bus.
27. The apparatus of any of clauses 24-26, in which the paging constraints define a quantity of times node outputs are paged out from the at least one local memory to at least one global memory.
28. The apparatus of any of clauses 24-27, in which the paging constraints defines whether node outputs are paged into the at least one local memory from at least one global memory or paged out from the at least one local memory to the at least one global memory.
29. The apparatus of any of clauses 24-28, in which the rematerialization constraints define a quantity of times that a node is permitted to be recomputed.
30. The apparatus of any of clauses 24-29, in which the rematerialization constraints include data dependencies determined based on the edges connecting the multiple nodes.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (c.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), crasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (c.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one local memory;
at least one global memory; and
at least one processor coupled to the at least one local memory and the at least one global memory, the at least one processor configured to:
receive a graph representing an artificial neural network (ANN), the graph including multiple nodes connected by edges and each node represents an operation;
determine retention intervals for outputs of the multiple nodes based on rematerialization constraints and paging constraints, the retention intervals corresponding to a time interval for retaining each node output in the at least one local memory; and
determine a sequence of tasks for executing the multiple nodes based on the retention intervals.

2. The apparatus of claim 1, in which the retention intervals are determined using a joint optimization of communication between the at least one local memory and the at least one global memory based on the rematerialization constraints and the paging constraints to reduce the communication between the at least one local memory and the at least one global memory.

3. The apparatus of claim 2, in which the communication between the at least one local memory and the at least one global memory is conducted using a double data rate (DDR) bus.

4. The apparatus of claim 1, in which the paging constraints define a quantity of times node outputs are paged out from the at least one local memory to the at least one global memory.

5. The apparatus of claim 1, in which the paging constraints defines whether node outputs are paged into the at least one local memory from the at least one global memory or paged out from the at least one local memory to the at least one global memory.

6. The apparatus of claim 1, in which the rematerialization constraints define a quantity of times that a node is permitted to be recomputed.

7. The apparatus of claim 1, in which the rematerialization constraints include data dependencies determined based on the edges connecting the multiple nodes.

8. The apparatus of claim 1, in which the at least one local memory comprises a tightly-coupled memory.

9. A processor-implemented method performed by at least one processor, the processor-implemented method comprising:
receiving a graph representing an artificial neural network (ANN), the graph including multiple nodes connected by edges and each node represents an operation;
determining retention intervals for outputs of the multiple nodes based on rematerialization constraints and paging constraints, the retention intervals corresponding to a time interval for retaining each node output in at least one local memory; and
determining a sequence of tasks for executing the multiple nodes based on the retention intervals.

10. The processor-implemented method of claim 9, in which the at least one processor is further configured to determine the retention intervals using a joint optimization of communication between the at least one local memory and at least one global memory based on the rematerialization constraints and the paging constraints to reduce the communication between the at least one local memory and the at least one global memory.

11. The processor-implemented method of claim 10, in which the communication between the at least one local memory and the at least one global memory is conducted using a double data rate (DDR) bus.

12. The processor-implemented method of claim 9, in which the paging constraints define a quantity of times node outputs are paged out from the at least one local memory to at least one global memory.

13. The processor-implemented method of claim 9, in which the paging constraints define whether node outputs are paged into the at least one local memory from at least one global memory or paged out from the at least one local memory to the at least one global memory.

14. The processor-implemented method of claim 9, in which the rematerialization constraints define a quantity of times that a node is permitted to be recomputed.

15. The processor-implemented method of claim 9, in which the rematerialization constraints include data dependencies determined based on the edges connecting the multiple nodes.

16. The processor-implemented method of claim 9, in which the at least one local memory comprises at least one tightly-coupled memory.

17. A non-transitory computer-readable medium having program code recorded thereon, the program code executed by a processor and comprising:
program code to receive a graph representing an artificial neural network (ANN), the graph including multiple nodes connected by edges and each node represents an operation;
program code to determine retention intervals for outputs of the multiple nodes based on rematerialization constraints and paging constraints, the retention intervals corresponding to a time interval for retaining each node output in at least one local memory; and
program code to determine a sequence of tasks for executing the multiple nodes based on the retention intervals.

18. The non-transitory computer-readable medium of claim 17, in which the program code comprises program code to determine the retention intervals using a joint optimization of communication between the at least one local memory and at least one global memory based on the rematerialization constraints and the paging constraints to reduce the communication between the at least one local memory and the at least one global memory.

19. The non-transitory computer-readable medium of claim 18, in which the communication between the at least one local memory and the at least one global memory is conducted using a double data rate (DDR) bus.

20. The non-transitory computer-readable medium of claim 17, in which the paging constraints define a quantity of times node outputs are paged out from the at least one local memory to at least one global memory.

21. The non-transitory computer-readable medium of claim 17, in which the paging constraints defines whether node outputs are paged into the at least one local memory from at least one global memory or paged out from the at least one local memory to the at least one global memory.

22. The non-transitory computer-readable medium of claim 17, in which the rematerialization constraints define a quantity of times that a node is permitted to be recomputed.

23. The non-transitory computer-readable medium of claim 17, in which the rematerialization constraints include data dependencies determined based on the edges connecting the multiple nodes.

24. An apparatus, comprising:
means for receiving a graph representing an artificial neural network (ANN), the graph including multiple nodes connected by edges and each node represents an operation;
means for determining retention intervals for outputs of the multiple nodes based on rematerialization constraints and paging constraints, the retention intervals corresponding to a time interval for retaining each node output in at least one local memory; and
means for determining a sequence of tasks for executing the multiple nodes based on the retention intervals.

25. The apparatus of claim 24, further comprising means for determining the retention intervals using a joint optimization of communication between the at least one local memory and at least one global memory based on the rematerialization constraints and the paging constraints to reduce the communication between the at least one local memory and the at least one global memory.

26. The apparatus of claim 25, in which the communication between the at least one local memory and the at least one global memory is conducted using a double data rate (DDR) bus.

27. The apparatus of claim 24, in which the paging constraints define a quantity of times node outputs are paged out from the at least one local memory to at least one global memory.

28. The apparatus of claim 24, in which the paging constraints defines whether node outputs are paged into the at least one local memory from at least one global memory or paged out from the at least one local memory to the at least one global memory.

29. The apparatus of claim 24, in which the rematerialization constraints define a quantity of times that a node is permitted to be recomputed.

30. The apparatus of claim 24, in which the rematerialization constraints include data dependencies determined based on the edges connecting the multiple nodes.
